(19) United States
(12) Patent Application Publication
(10) Pub. No.: US 2008/0246537 A1
(43) Pub. Date: Oct. 9, 2008

(54) Programmable discontinuity resistors for reference ladders

(75) Inventor: Joseph Aziz, Singapore (SG)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/905,824

(22) Filed: Oct. 4, 2007

Related U.S. Application Data
(60) Provisional application No. 60/907,473, filed on Apr. 3, 2007.

(51) Int. Cl. G05F 3/02

(52) U.S. Cl. 327/540

(57) ABSTRACT

A reference ladder having a plurality of embedded, programmable discontinuity resistors for adjusting the output voltages at a plurality of output taps of the ladder. In an embodiment, each discontinuity resistor has a programmable resistance. The reference ladder is factory tested to determine the voltage outputs at a plurality of output taps. A difference between the measured output voltages and the nominal output voltages is calculated. A determination is made of optimized resistances of the discontinuity resistors in order to minimize the differences between measured and nominal output voltages. The discontinuity resistors are then programmed, with the desired resistances stored in a non-volatile memory of the reference ladder. The output of the reference ladder may be further adjusted by using a trimming network at the bottom of the ladder to add a uniform offset to all the output voltages of all the output taps.

### CROSS REFERENCE TO RELATED APPLICATIONS

This patent application claims the benefit of U.S. Provisional Patent Application No. 60/907,473, filed Apr. 3, 2007, entitled “Trimming Scheme For Switching Regulators,” which is incorporated herein by reference in its entirety.

### BACKGROUND OF THE INVENTION

1. Field of the Invention

The present invention pertains to the field of providing a programmable reference voltage from a reference voltage generator, such as a bandgap reference in combination with a reference ladder. More particularly, the invention pertains to a system and method for ensuring that the actual voltage delivered via the reference ladder is configurably close to a nominal or theoretically expected voltage.

2. Background Art

For many electrical applications it is desirable to have a voltage source which can supply any of several selectable voltages. Moreover, many contemporary technologies require highly accurate voltages, for example because the device in question functions within expected parameters only when properly powered with an expected voltage, or because the voltage source may be used as a reference for electrical measurements or other measurements.

For example, some analog-to-digital converters (ADCs) employ a voltage reference ladder (also called a “resistor ladder”) which provides a reference voltage, and which is utilized by the ADC to quantize an incoming analog signal. More specifically, a bank of ADC comparators or differential input stages compares the reference voltages from the reference ladder to an input analog signal in order to quantize the analog signal and generate a digital output signal.

Another application of a device which can supply any of several selectable voltages would be a general purpose power supply (such as one intended to convert standard AC wall current to specific DC voltages), where the power supply may possibly be employed to provide power to any of several different devices which each require different DC voltage levels. Such a power supply may employ any number of front-ends, such as a switching regulator, to generate a single stable voltage, and may then employ at the output stage a reference ladder to make available a choice of specific output voltages.

Whether employed as part of a stand-alone power supply unit or as an element within a larger invention (such as an ADC), a reference ladder may be characterized by “nominal output voltages”, which may be defined as the voltages that are theoretically expected based on the design of a bandgap reference (or other nominally stable voltage source) in combination with the reference ladder. As is illustrated in detail in conjunction with FIG. 1, FIG. 2A and FIG. 2B (discussed further below), a reference voltage generator, comprising both a bandgap reference (or other nominally stable voltage source) and reference ladder, may exhibit variations from the nominal voltage output due to a variety of factors.

Existing reference generators may employ a trimming network in an attempt to compensate for these errors. A trimming network is a bank of resistors which is typically placed at the end of a reference ladder, that is, between a lowest or end resistor of a reference ladder, and ground. The trimming network itself comprises a group of resistors, the purpose of which is to modify the overall resistance of the reference ladder, and thereby compensate for inaccuracies in the voltages delivered by the reference generator. However, a trimming network typically provides a single voltage offset to the output voltage, which appears uniformly or substantially uniformly across all voltage taps of the reference generator. Such a single offset value may provide optimum or near-optimum compensation at one or a few taps, while providing suboptimal offset voltage at other taps, and may even make the voltage offset problem still worse at yet other voltage taps.

What is needed, then, is a system and method for providing a localized means to compensate for errors in output voltages for an voltage tap or subset of voltage taps of a reference ladder. The result of such localized corrections is such that, in aggregate, optimum or improved output voltages are achieved for all or nearly all voltage taps.

### BRIEF SUMMARY OF THE INVENTION

The present invention meets the above-identified needs by providing a system and method for minimizing output voltage errors at a plurality of voltage taps of a reference ladder. As the reference ladder is typically a series of resistors with voltage taps between resistors, the present invention may employ two or more programmable discontinuity resistors which are placed in series with the resistors of the reference ladder, and spaced at intervals along the reference ladder. In one exemplary embodiment, discontinuity resistors may be placed at approximately equal intervals along the reference ladder, meaning that equal numbers or substantially equal numbers of resistors are found in series between any two discontinuity resistors, or between an end node of the reference ladder and a first (or last) discontinuity resistor. In alternative embodiments, the spacing of the discontinuity resistors (that is, the relative numbers or percentages of ladder resistors between them) may vary within the scope of the present invention.

The output voltages at a plurality of the voltage taps are measured, and a determination is made of the differences between the measured output voltages and the nominal (that is, the expected) output voltages. These differences may be considered to be output voltage errors. The discontinuity resistors are configurable and/or programmable, so that it is possible to set the resistance of each discontinuity resistor. One or more discontinuity resistors are configured or programmed to specific resistances, such that the resulting changes in resistances along segments of the reference ladder results in reduced output voltage errors at the voltage taps. The programming of the discontinuity resistors may be stored in a permanent or semipermanent memory associated with the reference ladder, such that when in operation the reference ladder continues to deliver the output voltages with reduced output voltage errors.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears (for example, an element labeled 310 typically first appears in the drawing labeled FIG. 3).

FIG. 1 illustrates an exemplary conventional reference voltage generator employing a reference ladder to generate a range of output voltages at voltage taps of the conventional reference voltage generator.

FIG. 2A is an exemplary plot reflecting, for an exemplary conventional reference voltage generator employing a reference ladder, the difference between a nominal output voltage and an actual output voltage.

FIG. 2B is an exemplary plot reflecting, for an exemplary conventional reference voltage generator employing a reference ladder, the difference between a nominal output voltage and an actual output voltage when a trimming network is added to the bottom of a reference ladder.

FIG. 3 illustrates an exemplary reference ladder with a plurality of exemplary discontinuity resistors according to an exemplary embodiment of the present invention.

FIG. 4A is an exemplary plot of output voltage vs. reference code for an exemplary reference ladder according to an exemplary embodiment of the present invention.

FIG. 4B is another exemplary plot of output voltage vs. reference code for an exemplary reference ladder according to an exemplary embodiment of the present invention.

FIG. 5 illustrates an exemplary discontinuity resistor according to an embodiment of the present invention.

FIG. 6 illustrates an exemplary reference voltage generator with programmable discontinuity resistance according to an embodiment of the present invention.

FIG. 7 is a flowchart of an exemplary method for setting resistance values for discontinuity resistors.

### DETAILED DESCRIPTION OF THE INVENTION

1. Introduction
2. Exemplary Trimming Network With Discontinuity Resistors
3. Exemplary Discontinuity Resistor
4. Exemplary Reference Voltage Generator With Programmable Discontinuity Resistance
5. Exemplary Method for Setting Values for Discontinuity Resistors
6. Further Exemplary Embodiments
7. Conclusion

### 1. Introduction

The present invention is directed to a system and method for using configurable resistors known as discontinuity resistors in a reference ladder to shift an actual output reference voltage closer to a nominal output voltage at one or more voltage taps of the reference ladder. A reference ladder can be referred to, equivalently and synonymously, as a “resistor ladder”. The term “reference ladder” is employed exclusively in the following discussion, associated figures, and appended claims. It is understood that the discussion, figures, and appended claims pertain to a resistor ladder as well.

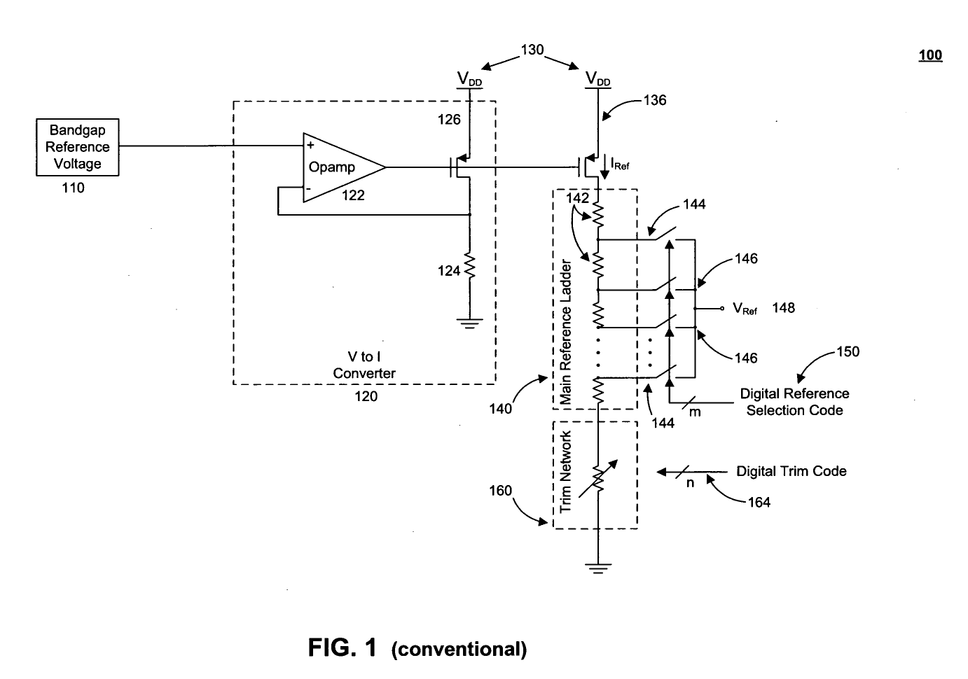

FIG. 1 illustrates an exemplary conventional reference voltage generator 100 employing a reference ladder to generate a range of output voltages at voltage taps of the reference voltage generator 100. Exemplary reference voltage generator 100 may include a bandgap reference 110 (that is, a fixed, nominally stable DC voltage source that does not vary significantly with temperature) or some other nominally stable, consistent reference voltage source 110, and a voltage-to-current converter 120 which includes op-amp 122, resistor 124, and FET 126. Op-amp 122 employs negative feedback to ensure that the voltage across resistor 124 substantially matches the voltage provided from the nominally stable voltage source 110. The op-amp 122 controls the current of FET 126 so that voltage across the resistor 124 matches the nominally stable voltage source 110.

The gate of FET 126 is connected to the gate of FET 136, forming a current mirror, so that the current drawn via the FET 126 is mirrored to I_{Ref} that is flowing through FET 136. The current I_{Ref} passes through reference ladder 140, which includes series resistors 142 (sometimes referred to herein, synonymously, as “ladder resistors” 142 or “base resistors” 142) and voltage taps 144 that couple to a reference voltage output 148 through controllable switches 146. Each resistor of base resistors 142 is a fixed resistor. A desired output voltage 148 may be selected by using a digital reference selection code 150 to close one of switches 146, each of which selects a voltage from one of the voltage taps 144. Switches 146 may be FETs or other types of transistors that are well known in the art. It is noted that voltage taps 144 are sometimes referred to herein, equivalently and for brevity, simply as “tap” 144 or “taps” 144.

While exemplary reference voltage generator 100 theoretically has a precisely controlled output voltage for each voltage tap 144, actual voltage output voltage may vary from the nominal output voltage over time. Variations from the nominal voltage output may arise due to such factors as bandgap voltage variations (since, for example, the bandgap reference may not be completely insensitive to temperature variations), voltage-to-current opamp offset, errors in current source mirroring, and resistor mismatches.

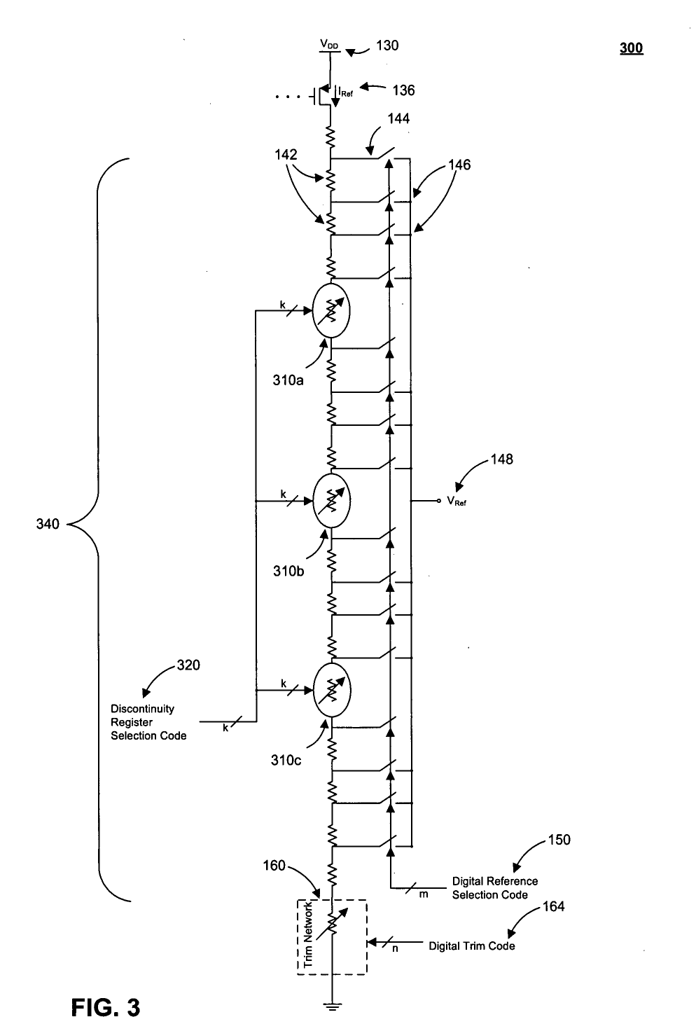

Because a desired output voltage 148 may be selected by using a digital reference selection code 150, exemplary reference voltage generator 100 may be considered a programmable device (that is, the output voltage 148 may be programmed via the digital reference selection code 150). In other words, reference voltage generator 100 may be considered programmable in terms of selecting a voltage tap 144 from which an output voltage 148 may be taken. However, reference voltage generator 100 is not programmable in the sense of programming a change or adjustment to the voltage level associated with any particular voltage tap 144. Such programming may be accomplished however, by means of an exemplary trimming network with discontinuity resistors, as configured and employed in the present invention. This is discussed further below in conjunction with FIGS. 3 through 7, and further in conjunction with the discussion in Section 6 below, entitled “Further Exemplary Embodiments”.

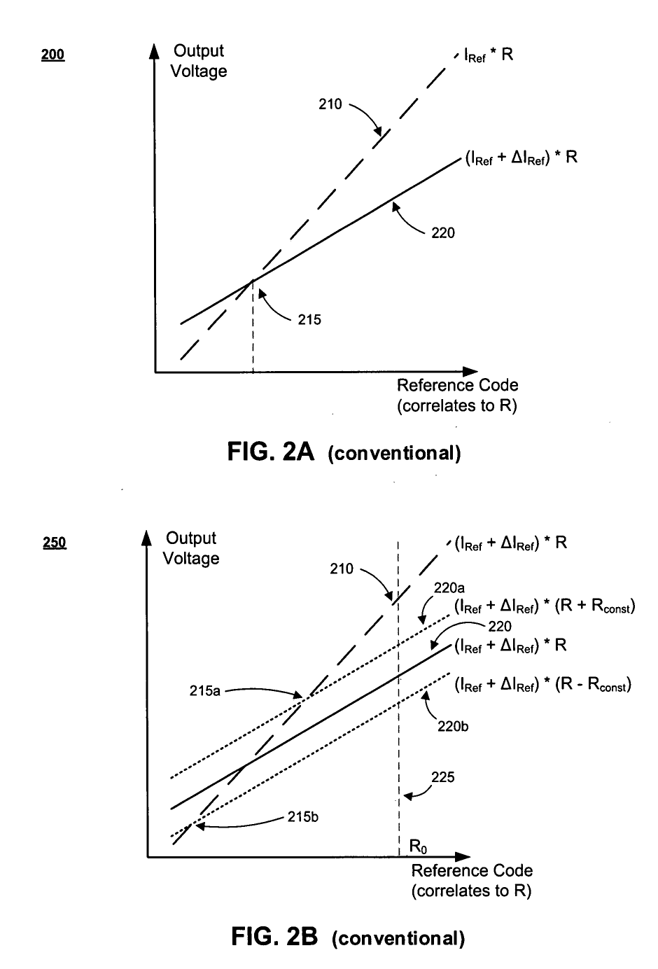

FIG. 2A is an exemplary plot 200 reflecting a difference between a nominal output voltage and an actual output voltage for an exemplary reference voltage generator 100 employing a reference ladder 140. Specifically, plot 200 plots output voltage as a function of a selected reference code associated with a voltage tap 144 of reference ladder 140. The value of “R” in the formula:

(I_{Ref}+ΔI_{Ref})*R

is a total resistance at points along the reference ladder; that is, “R” increases and decreases as the Reference Code value of the horizontal axis increases and decreases. Further, it is noted that the error increases from the crossing point 215 of the diagram.

Dashed plotline 210 shows an exemplary nominal output, which reflects the nominal current flow I_{Ref} discussed above. Solid plotline 220 shows an exemplary actual output 220, which reflects a current flow (I_{Ref}+ΔI_{Ref}) which is different from the nominal current flow I_{Ref}. ΔI_{Ref} may be a consequence of the various output-offsetting factors discussed above (bandgap voltage variations, voltage-to-current opamp offset, errors in current source mirroring, resistor mismatches, and other factors). It can be seen that due to the presence of ΔI_{Ref}, actual output 220 has a different slope than nominal output 210. Therefore, the actual output matches the nominal output at, at most, a single voltage tap, as indicated by point 215 where lines 210 and 220 intersect. Further, it is noted that the error increases from the crossing point 215 of the diagram.

A means to address this difference between actual voltage output and nominal voltage output is shown in FIG. 1. Specifically, a trimming network 160 may be added at the bottom of the reference ladder, that is, between a lowest resistor of the resistor network and ground. Trimming network 160 is itself composed of one or more resistors, and a digital trim code 164 or other means may be employed to selectively program the exact resistance of trimming network 160. As a result of the presence of trimming network 160, a constant offset is added to all the output voltages at all the voltage taps 144 of reference ladder 148.

However, this solution (that is, adding a trimming network 160 at the bottom of the reference ladder) falls short of the desired goal. FIG. 2B shows the result of adding trimming network 146. Specifically exemplary plot 250 shows two possible, exemplary new output plotlines 220a and 220b which may result from adding trimming network 160. Exemplary output plotline 220a is above output plotline 220 and exemplary output plotline 220b is below output plotline 220. In either case (220a or 220b), the net effect is simply to shift the output plotline up or down in relation to original output plotline 220. The point at which the actual output voltage is the same as the nominal output voltage is also shifted (points 215a and 215b reflect exemplary new points where actual and nominal output voltages are the same). However, it can be clearly seen from plot 250 that for some voltage taps, the difference between the actual output voltage 220 and nominal output voltage 210 may actually be greater than was the difference without trimming network 160.

Consider for example the voltage tap associated with reference code R₀ (intersected by dashed vertical line 225): the difference between the output voltage associated with plotline 220b (which in turn is associated with a ladder with an exemplary trimming network) and the corresponding nominal output voltage of plotline 210 is greater than the difference between the output voltage associated with plotline 220 (associated with a reference ladder without trimming network) and the same nominal output voltage.

2. Exemplary Trimming Network with Discontinuity Resistors

FIG. 3 illustrates a reference ladder 340 and associated elements (labeled in aggregate as 300), according to an exemplary embodiment of the present invention. Reference ladder 340 and associated elements includes numerous elements 130, 136, 144, 146, 148, 150, 160, 164 already discussed above, the details of which will not be repeated here. However, in one embodiment of the present invention, reference ladder 340 also includes exemplary discontinuity resistors 310 which are inserted along the reference ladder at intervals between selected voltage taps 144. Any number of discontinuity resistors 310 could be used depending on the specific application, even though three discontinuity resistors 310a-c are shown. In an alternative embodiment (not shown), some or all of the discontinuity resistors 310 may be placed between a ladder resistor 142 and a voltage tap 144.

A discontinuity resistor 310 may be viewed as a configurable, variable resistor which is embedded within the chain of resistors 142 and/or voltage taps 144 of reference ladder 340. As will be discussed in greater detail below, a discontinuity resistor 310 is a variable resistor which may be programmed to have a desired resistance value, so that one or more discontinuity resistors 310 may have a different resistance from any other discontinuity resistor 310. Programming of each discontinuity resistor 310 may be done via a discontinuity resistor selection code line 320, which may both select for a desired discontinuity resistor 310, and program the specific resistance of a selected discontinuity resistor 310. Some or all of the discontinuity resistors 310 will typically be configured to have a resistance that is different from that of the resistors 142 that make up the reference ladder 340, where the resistors 142 will typically have a common resistance value.

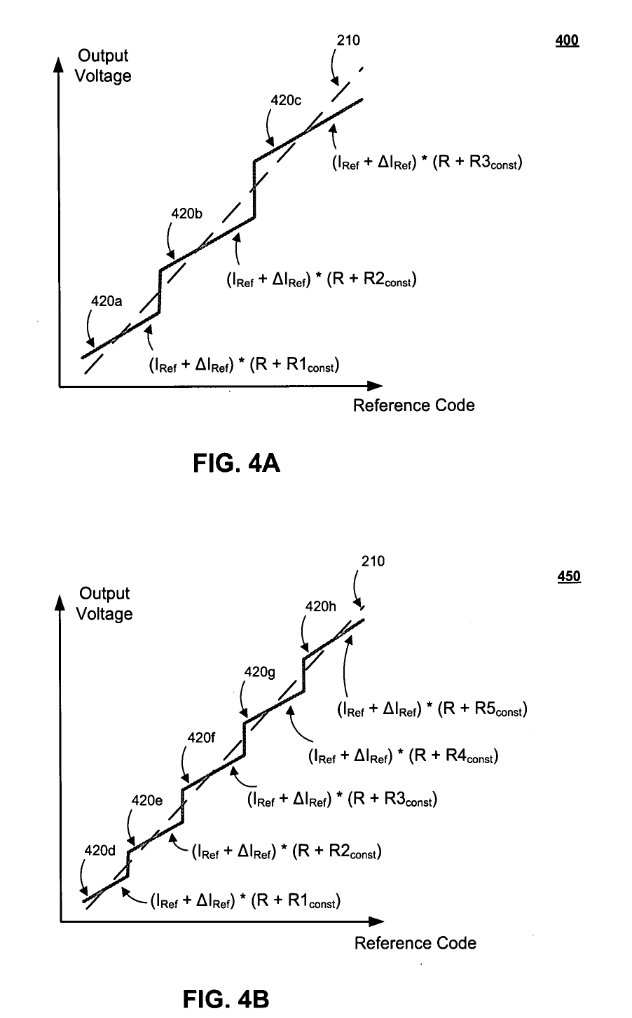

When programmed with appropriate resistance values according to exemplary methods discussed further below, discontinuity resistors 310 introduce discontinuities into the plotline of output voltage vs. reference code for the reference ladder. This is illustrated in plot 400 of FIG. 4A. Plotline 420 of output voltage as a function of reference code (that is, as a function of voltage tap) consists of three sloped segments 420a, 420b, and 420c. Each segment 420a, 420b, 420c corresponds to a segment of reference ladder 140 terminated by a discontinuity resistor 310. Because of the presence of each discontinuity resistor 310, each segment of reference ladder 340 has a different constant resistance R1_{const}, R2_{const}, and R3_{const} added to it, as shown in the exemplary formulas seen on plot 400. This results in different vertical offsets of segments 420a, 420b, 420c of plotline 420. (Note that a given constant value RN_{const}, where ‘N’ may be 1, 2, 3, etc., may be a consequence of the effect of two or more of the discontinuity resistors.)

The overall result is that the output voltages of reference ladder 340 with discontinuity resistors 310 conform more closely to the nominal output voltages 210, as compared with the output voltages that result from a reference ladder 140 that does not have discontinuity resistors.

Persons skilled in the relevant arts will recognize that more or fewer discontinuity resistors may be employed in the reference ladder, with variations in placement as well. Plot 450 of FIG. 4B shows that by using even more discontinuity resistors, it is possible to achieve a plotline 420 with even more segments, 420d-420h. The result is an output from the reference ladder 340 which conforms even more closely with nominal output voltage plotline 210.

### 3. Exemplary Discontinuity Resistor

A discontinuity resistor 310 may be a variable resistor which may be configured or programmed to have a desired resistance value. Any one discontinuity resistor 310 may be configured or programmed to have a different resistance value from one, several, or all of the other discontinuity resistors 310. Any one, several, or all of discontinuity resistors 310 may also be configured or programmed to have a different resistance value from base resistors 142.

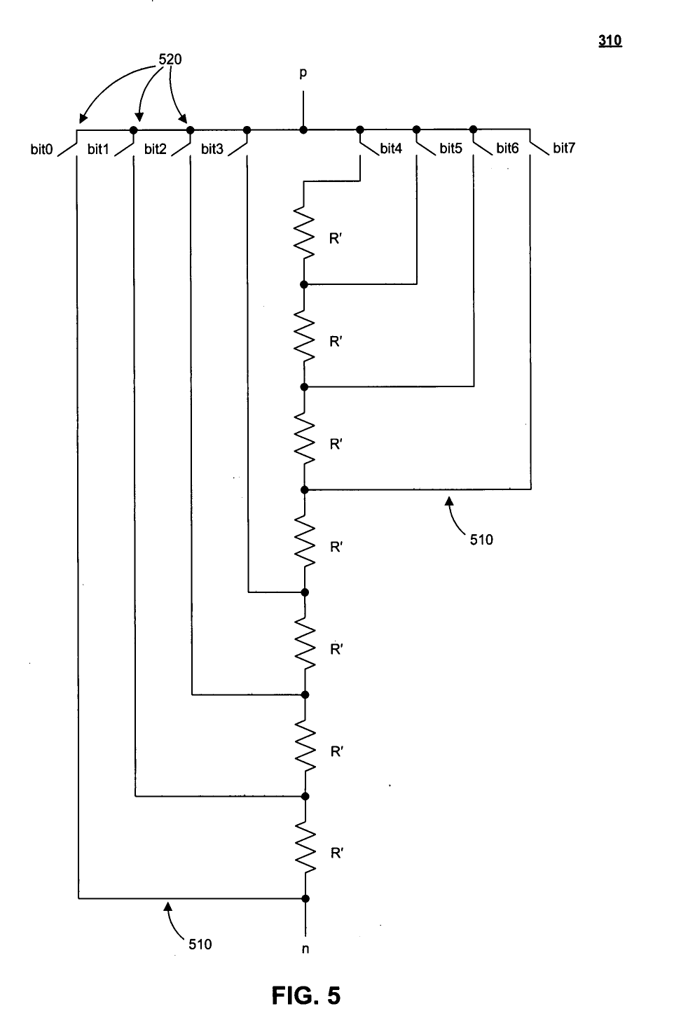

FIG. 5 illustrates an exemplary discontinuity resistor according to one embodiment of the present invention. A plurality of resistors R′ are placed in series between end-nodes p and n of the discontinuity resistor. Leads 510 connect end-node p to points between each of resistors R′, so that the leads 510 provide taps from the reference ladder that is made up of the resistors R′. Each lead 510 has an associated switch 520. Closing the switched labeled “bit4” and opening all other switches 520 results in a maximum resistance of discontinuity resistor 310, because the path between the p and n nodes must travel through all of the resistors R′. Closing the switch labeled “bit0” and opening all other switches 520 results in a minimum resistance of discontinuity resistor 310 because all of the resistor R′ are bypassed.

Persons skilled in the relevant arts will recognize that for the configuration shown, any of eight different resistance values can be established by closing any one of switches “bit0” through “bit7 ”, while opening other switches 520, thereby incrementally changing the number of resistors R′ between the end-nodes p and n. Further, it will be realized that each of the multiple discontinuity resistors 310 can be programmed to have a different resistance, by using a different, per-discontinuity-resistor-specific control code to control the switches 310 for each respective discontinuity resistor.

Persons skilled in the relevant arts will recognize that more or fewer resistors R′ may be used, along with corresponding switches 520. Switches 520 may be FETs or other types of transistors, or other types of gates (not illustrated). A permanent resistance value may be programmed for discontinuity resistor 310 by using non-volatile memory (not illustrated) to store a setting for each of switches 520.

Persons skilled in the relevant arts will recognize that other configurations of resistors and switches may be employed as well to create a discontinuity resistor within the scope and spirit of the present invention.

### 4. Exemplary Reference Voltage Generator With Programmable Discontinuity Resistance

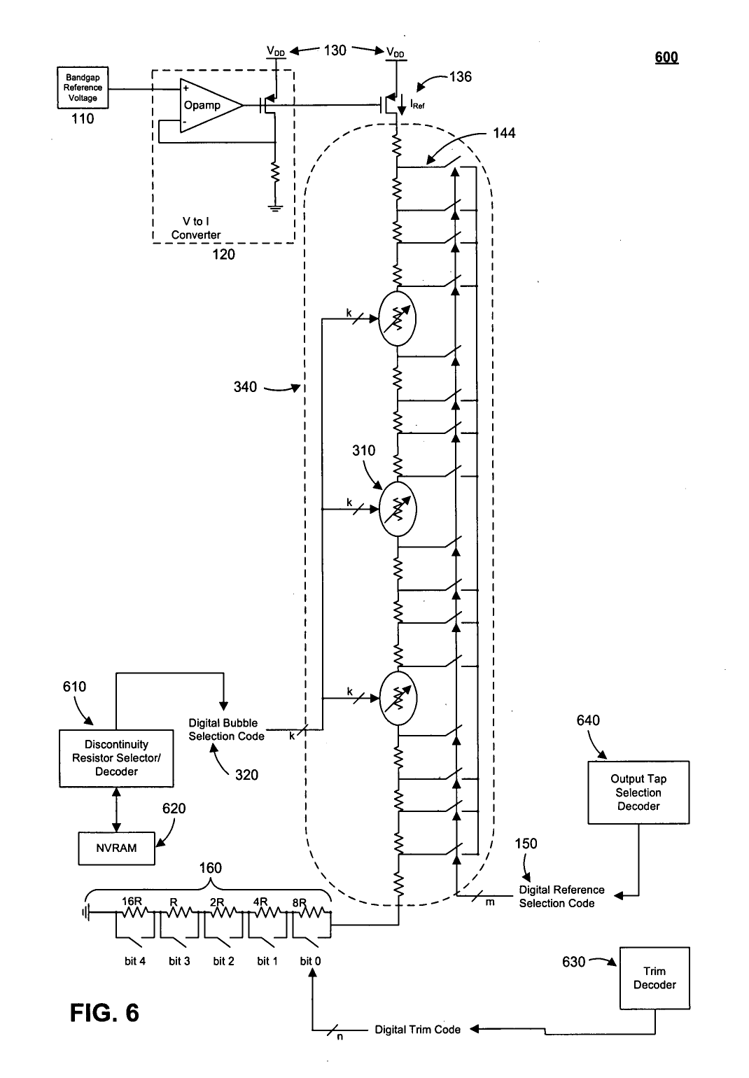

FIG. 6 illustrates an exemplary system 600 according to the present invention, where system 600 is a reference voltage generator with programmable discontinuity resistance. Exemplary system 600 will be referred to herein as “programmable-discontinuity-resistance reference voltage generator 600”. Programmable-discontinuity-resistance reference voltage generator 600 includes a bandgap reference 110 or similar nominally stable voltage source 110, a voltage to current converter 120, and current mirror 130, which in combination provides constant reference current I_{Ref}. These elements have already been discussed above in conjunction with FIG. 1. As already noted above in conjunction with FIG. 2A, the actual reference current I_{Ref} provided may not be equal to the nominal reference current I_{Nom}, but may instead be: I_{RefActual}=I_{RefNominal}+ΔI_{Ref}. In addition, resistors in reference ladder 340 may not always obtain their nominal values. For these and related reasons, and without the introduction of additional elements (such as discontinuity resistors 310), the output voltages obtained from voltage taps 144 may not always equal the nominal values.

Reference ladder 340 therefore contains discontinuity resistors 310, discussed above with reference to FIG. 3. As discussed above in relation to FIG. 3 and FIG. 4, discontinuity resistors 310 may result in different segments of reference ladder 340 having a different constant resistance R1_{const}, R2_{const}, R3_{const}, etc., added to it (see plot 400 of FIG. 4A and plot 450 of FIG. 4B). With a proper selection of resistances for discontinuity resistors 310—and as a consequence appropriate, resulting values for R1_{const}, R2_{const}, R3_{const}, etc.—the result is that the outputs at voltage taps 144 of reference ladder 340 are closer to their nominal values as compared with a similar reference ladder 140 without discontinuity resistors 310. As an additional means to optimize the output voltages at voltage taps 144 with respect to the nominal output voltages, a trimming resistor 160 may be employed to add a uniform offset to the output voltages at all voltage taps 144.

As noted above in conjunction with FIG. 5, a discontinuity resistor 310 may have one or more internal switches 520, such as transistors or logic gates, which are used to establish a desired resistance for discontinuity resistor 310. The state of an internal switch 520 (that is, a setting such as on or off, or open or closed) in turn may be controlled by a discontinuity resistor selector/decoder 610.

In one embodiment of the present invention, selector/decoder 610 may be external to the reference ladder 340 proper, and hence external to each discontinuity resistor 310. Selector/decoder 610 selects the on/off or open/closed status of each internal switch 520 in each discontinuity resistor 310, and by this means determines the overall resistance for each discontinuity resistor 310. Selector/decoder 610 is programmable by means of control circuits, communications channels, and/or a processor or microprocessor (not shown), so that the resistance of each discontinuity resistor 310 is separately programmable, to provide a separate resistance. Selector/decoder 610 may have an associated memory, such as NVRAM 620, which stores the states of internal switches 520 in the discontinuity resistors 310. In this way, it is possible for exemplary programmable-discontinuity-resistance reference voltage generator 600 to store a set of optimized resistance values for discontinuity resistors 310 even when power is removed from programmable-discontinuity-resistance reference voltage generator 600.

In an alternative embodiment, each discontinuity resistor 310 may have its own, onboard selector/decoder 610 to program the internal switches of the discontinuity resistor 310. In an alternative embodiment, each discontinuity resistor 310 may have its own, onboard memory 620 to store an optimized state, that is, an optimized resistance value, for each discontinuity resistor 310. In an alternative embodiment, memory 620 may store more than one set of internal settings for discontinuity resistors 310, enabling reference ladder 340 to be programmable with a plurality of output voltages for each voltage tap 144.

Trimming resistor 160 may also be programmable via trim decoder 630. Trim decoder 630 may also employ memory 620 to store switch settings (and hence, a total resistance) for trim resistor 160, or trim decoder 630 may have its own separate memory (not shown) to store resistance settings for trim resistor 160.

### 5. Exemplary Method for Setting Values for Discontinuity Resistors

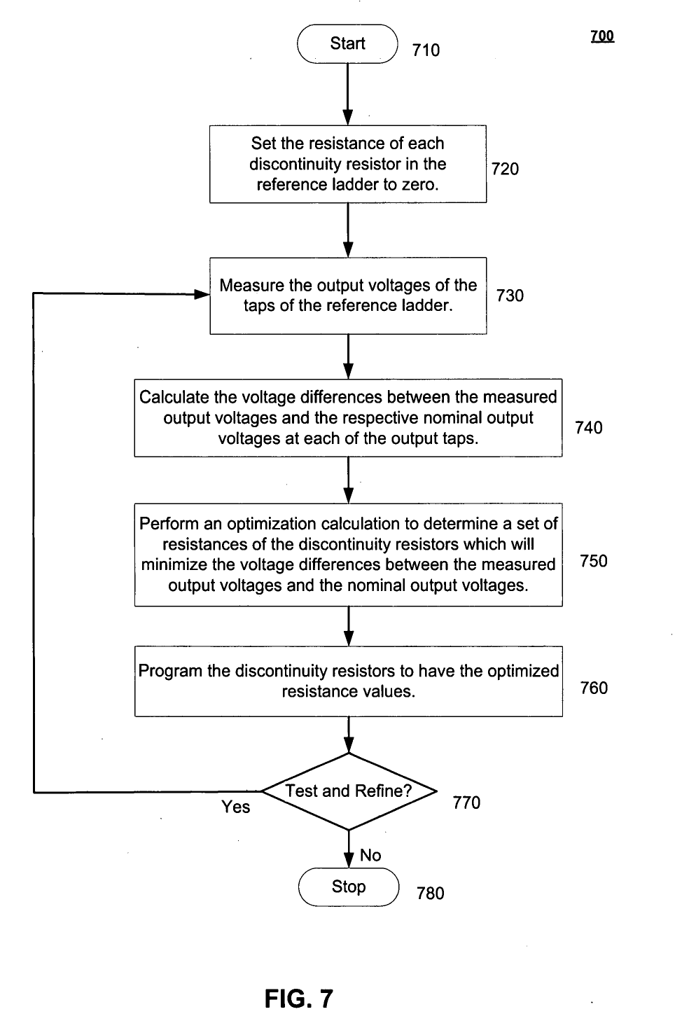

FIG. 7 is a flowchart of an exemplary method 700 for setting resistance values for discontinuity resistors 310.

Method 700 starts at step 710. At step 720, each discontinuity resistor 310 in the reference ladder 340 may be set to an particular resistance anywhere between the minimum and maximum resistance value, inclusive. In one embodiment of method 700, each discontinuity resistor 310 may be set to have zero resistance. In an alternative embodiment, some or all of the discontinuity resistors 310 may be set to have non-zero resistance values. Setting the resistance values may be done via the discontinuity selector/decoder 610, as already discussed above.

In step 730, a measurement is made of the output voltages at one or more of the voltage taps 144 of the resistance ladder. One or more voltage taps 144 may be selected in via voltage tap selection decoder 640, as already discussed above.

In step 740, a calculation is made to determine the difference between the actual output voltage (that is, the measured output voltage) at each voltage tap 144, and the nominal output voltage at each of the respective voltage taps 144.

In step 750, an optimization calculation is performed to determine a resistance for a discontinuity resistor 310, or a set of resistances for a set of respective discontinuity resistors 310, such that the difference between the expected output voltages and the nominal output voltages will be minimized. Persons skilled in the relevant arts will recognize that a variety of minimization constraints may be defined, and a variety of optimization algorithms may be employed. Persons skilled in the relevant arts will further recognize that the choice of minimization constraints and optimization algorithms may be constrained in part by the particular architecture of reference ladder 340, including the nominal resistances of the resistors 142 in the ladder, the number of voltage taps 144, and the number, placement, and resistance ranges of discontinuity resistors 310.

Not shown in FIG. 7 is an additional, optional step, which may entail that as part of the optimization process, a desired resistance may be calculated for trimming resistor 160, which thereby establishes a uniform voltage offset across all voltage taps 144 of reference ladder 340.

In step 760, discontinuity resistors 310 are programmed to have the optimized resistance values. This programming may be accomplished via discontinuity resistor selector/decoder 610, as already discussed above. This programming may entail storing the resistance values in memory 620 as already discussed above. This programming may further entail programming the resistance of trimming network 160.

Optional step 770 may entail a decision to test and refine the discontinuity resistor/trimming network resistance values established via method 700. If a decision is made to test and refine the resistance values, the method returns to step 730. If a decision is made to not test and refine the resistance values, the method stops at step 780.

### 6. Further Exemplary Embodiments

In one exemplary embodiment of the present system and method, reference ladder 340 may consist of a number of resistors 142 coupled in series, whose purpose is specifically to serve as voltage dividers, and which may be referred to as base resistors 142. The number of such base resistors 142 may vary, but in one exemplary embodiment may be on the order of several dozen base resistors 142. In an alternative embodiment, over one hundred base resistors 142 may be arranged in series. Each base resistor 142 will typically have the same nominal resistance value, and even allowing for manufacturing imperfections and materials' variations, each base resistor 142 may have substantially the same, fixed resistance as all the other base resistors 142.

In one embodiment a voltage tap 144 may be positioned between every pair of base resistors 142. Voltage taps 144 may also be placed at either or both end nodes of reference ladder 340. In an alternative embodiment, voltage taps 144 may be positioned less frequently along reference ladder 340, for example between every other base resistor 142. Voltage taps 144 are for obtaining reference voltages resulting from a current flowing through the base resistors and discontinuity resistors (discussed below).

Discontinuity resistors 310 are coupled in series with base resistors 142. In one exemplary embodiment of the present system and method, the number of discontinuity resistors 310 may be less than the number of base resistors 142, and may also be less than the number of voltage taps 144. For example, there may be just one discontinuity resistor 310 for every ten base resistors 142, or for every dozen base resistors 142. Other ratios between the number of base resistors 142 and the number of discontinuity resistors 310 may be implemented as well, with in general there being more base resistors 142 than discontinuity resistors 310.

In one exemplary embodiment, discontinuity resistors 310 are distributed uniformly along reference ladder 340, for example, with ten base resistors 142 between every two discontinuity resistors 310, or with some other equal multiple number of base resistors 142 between every two discontinuity resistors 310. In an alternative embodiment, discontinuity resistors 310 may not be distributed uniformly along reference ladder 340; however, more than one base resistor 142, as well as more than one voltage tap 144, may still typically be found in series between each pair of consecutive discontinuity resistors 310. A discontinuity resistor 310 may also be placed at an end node of reference ladder 340.

Unlike base resistors 142, which each have a substantially same resistance, each discontinuity resistor 310 may be set to have a resistance which is different from the resistances of base resistors 142. Moreover, each discontinuity resistor 310 of the multiple discontinuity resistors 310 may be set to have a different level of resistance from one or more other discontinuity resistors 310.

In one embodiment of the present system and method, each discontinuity resistor 310 has a fixed resistance. In an alternative embodiment, each discontinuity resistor 310 is programmable, meaning the resistance of each discontinuity resistor 310 may be programmed to fall anywhere within a range of possible resistance values. In the discussion which follows immediately below, it is assumed that each discontinuity resistor 310 is programmable; however, it should be understood that many similar considerations may apply to a discontinuity resistor 310 which has a fixed resistance.

In general, and as already discussed above, the resistances of the discontinuity resistors 310 are programmed so as to shift the actual output reference voltages at respective voltage taps 144 to be closer to a set of respective nominal output voltages at the respective taps 144.

In some applications of the present system and method, it may turn out to be the case that at least one discontinuity resistor 310 is programmed to have the same or nearly the same resistance as a base resistor 142. Similarly, in some applications of the present system and method, it may turn out to be the case that two or more discontinuity resistors 310 are programmed to have a common or substantially the same level of resistance. However, in application, it may equally turn out to be the case that all discontinuity resistors 310 are programmed to have different resistances than base resistors 142; similarly, in application, it may equally turn out to be the case that all discontinuity resistors 310 are programmed to have different resistances from any of the other discontinuity resistors 310.

As noted above, in one embodiment of the present system and method, discontinuity resistors 310 may be programmed via a discontinuity resistor selector/decoder 610 which is external to reference ladder 340 proper, and which may for example be part of a switching regulator or other system which is associated with reference ladder 340. Similarly, the determined or desired resistance values for discontinuity resistors 310 may be stored in a memory 620 which is external to reference ladder 340 proper, and which may for example be part of a switching regulator or other system which is associated with reference ladder 340. In an alternative embodiment, either discontinuity resistor selector/decoder 610 and/or memory 620 may be incorporated as part of reference ladder 340.

In one embodiment, reference ladder 340 includes a trimming network 160 appended to an end node, where the resistance of the trimming network 160 induces a substantially uniform offset in each actual output reference voltage of taps 144. In an alternative embodiment, reference ladder 340 does not include trimming network 160.

### 7. Conclusion

As will be appreciated by persons skilled in the relevant art(s), the system(s) and method(s) described here represent only one possible embodiment of the present invention. Many of the elements described herein could, in alternative embodiments of the present invention, be configured differently within the scope and spirit of the present invention. In addition, additional elements, or a different organization of the various elements, could still implement the overall effect and intent of the present system and method. Therefore, the scope of the present invention is not limited by the above disclosure and detailed embodiments described therein, but rather is determined by the scope of the appended claims.

What is claimed is:

1. A reference ladder configured to accept a current from a current source, comprising:
a plurality of resistors coupled in series;
a plurality of taps interspersed between said resistors for obtaining a plurality of reference voltages resulting from said current flowing through said plurality of resistors; and
a plurality of discontinuity resistors, wherein a discontinuity resistor of the plurality of discontinuity resistors is connected in series between a first resistor and a second resistor of said plurality of resistors.

2. The reference ladder of claim 1, further comprising a discontinuity resistor connected in series between at least one of:
a first tap and a second tap of said plurality of taps;
a tap of said plurality of taps and a resistor of said plurality of resistors;
an end node of said ladder and the tap of said plurality of taps; and
the end node of said ladder and the resistor of said plurality of resistors.

3. The reference ladder of claim 1, wherein a resistance of said discontinuity resistor is configurable to shift an actual output reference voltage closer to a nominal output voltage for at least two taps of the plurality of taps.

4. The reference ladder of claim 3, where said discontinuity resistor comprises a programmable resistance element, wherein said resistance of said discontinuity resistor is programmable.

5. The reference ladder of claim 1, wherein said discontinuity resistor comprises:
a plurality of coupled resistors; and
a plurality of switches, each switch coupled to a corresponding resistor of said plurality of coupled resistors, each switch configured to be switchable between a first switch state for conducting the current and a second switch state for not conducting the current;
wherein a plurality of switch states of the plurality of switches determines a total resistance of the discontinuity resistor.

6. The reference ladder of claim 5, wherein said discontinuity resistor is configured to be programmable by setting the switch states of the plurality of switches.

7. The reference ladder of claim 5, wherein a switch of the plurality of switches is configured to be switchable between a first switch state directing the flow of current along an electrical path and a second switch state blocking the flow of current along the electrical path;
wherein the electrical path directs the current through at least a resistor of the plurality of coupled resistors;
wherein a plurality of switch states of the plurality of switches determines a total resistance of the discontinuity resistor.

8. The reference ladder of claim 7, wherein said discontinuity resistor further comprises a first end node and a second end node;
wherein the plurality of coupled resistors are coupled in series between said first end node and said second end node;
wherein each switch of the plurality of switches has a first connection at the first end node and a second connection at a respective junction between two resistors of the plurality of resistors; and
wherein the total resistance of the discontinuity resistor is determined by setting a single switch of the plurality of switches to conduct the flow of current and setting a remaining set of switches of the plurality of switches to not conduct the flow of current.

9. The reference ladder of claim 7, wherein said discontinuity resistor comprises:
a first end node and a second end node;
a plurality of resistors coupled in series between said first end node and said second end node; and
a plurality of short-circuit paths, wherein a short-circuit path of the plurality of short-circuit paths is configured in parallel with at least a resistor of the plurality of resistors coupled in series;
a plurality of switches, wherein each switch of the plurality of switches is configured to open or close a respective short-circuit path of the plurality of the short-circuit paths;
wherein the total resistance of the discontinuity resistor is determined by setting zero, one, or more than one switch of the plurality of switches to open or close respective short-circuit paths.

10. The reference ladder of claim 1, further comprising a trimming network appended to at least one of the end node of said ladder, a final tap of said ladder, and a lowest tap of said ladder;
wherein said trimming network is an appended trimming network; and
wherein a resistance of said appended trimming network is configured to induce a substantially uniform offset in each actual output reference voltage of each of the plurality of taps.

11. The reference ladder of claim 1, wherein at least one of the discontinuity resistors has a resistance value that is different from a resistance value of a resistor of the plurality of resistors.

12. The reference ladder of claim 1, wherein at least one of the discontinuity resistors has a resistance value that is different from the other discontinuity resistors.

13. A reference voltage generator, comprising:
a plurality of discontinuity resistors coupled to a plurality of resistors of a reference ladder;
a plurality of voltage taps of the reference ladder, wherein the plurality of discontinuity resistors are configured to shift an actual output reference voltage closer to a nominal output voltage at an output tap of the plurality of voltage taps; and
a first decoder for programming the plurality of discontinuity resistors.

14. The reference voltage generator of claim 13, further comprising a current source for providing a reference current to said reference ladder.

15. The reference voltage generator of claim 13, further comprising a memory configured for storing a set of resistance values, said resistance values for determining a programmable resistance of the plurality of discontinuity resistors.

16. The reference voltage generator of claim 15, wherein said memory is further configured for storing a set of switch states, wherein said switch states determine a set of switch states of the discontinuity resistors, and wherein said switch states determine the programmable resistance of the discontinuity resistors.

17. The reference voltage generator of claim 13, further comprising at least one of:
an appended trimming network, said appended trimming network configured to induce a substantially uniform offset in an actual output reference voltage for each voltage tap of the plurality of voltage taps;
a set of transmission gates, said transmission gates configured to provide an output voltage from at least an voltage tap of the plurality of voltage taps; and
a voltage tap selection decoder configured to select the voltage tap of the plurality of voltage taps.

18. A reference ladder configured to accept a current from a current source, comprising:
a plurality of base resistors coupled in series, each base resistor of said plurality of base resistors having a substantially same, fixed resistance;
a plurality of discontinuity resistors, each discontinuity resistor of said plurality of discontinuity resistors being interspersed in series with said plurality of base resistors; and
a plurality of taps distributed along the series of resistors of said base resistors for obtaining a plurality of reference voltages resulting from said current flowing through said plurality of base resistors and said plurality of discontinuity resistors;
wherein a total number of said discontinuity resistors is less than a total number of said base resistors; and
wherein a resistance of a discontinuity resistor of said plurality of discontinuity resistors is different from the substantially same, fixed resistance of each base resistor.

19. The reference ladder of claim 18, wherein the discontinuity resistors are distributed among the base resistors; and
wherein the discontinuity resistor of said plurality of discontinuity resistors is connected in series between a first base resistor and a second base resistor of said plurality of base resistors or between a base resistor of said plurality of base resistors and an end node of said reference ladder.

20. The reference ladder of claim 18, wherein at least two base resistors are connected in series between any two consecutive discontinuity resistors of the plurality of discontinuity resistors.

21. The reference ladder of claim 18, wherein at least two voltage taps are distributed between any two consecutive discontinuity resistors of the plurality of discontinuity resistors.

22. The reference ladder of claim 18, wherein said discontinuity resistor comprises a programmable resistance element, wherein said resistance of said discontinuity resistor is programmable; and
wherein the resistances of said discontinuity resistors are programmable to shift a plurality of actual output reference voltages closer to a plurality of respective nominal output voltages at respective taps of the plurality of taps.

23. The reference ladder of claim 22, wherein a first discontinuity resistor of the plurality of discontinuity resistors is programmable to have a resistance value that is different from the resistance value of a second discontinuity resistor of the plurality of discontinuity resistors.

24. The reference voltage generator of claim 22, further comprising a memory configured for storing a set of resistance values, said set of resistance values for determining a programmable resistance of the plurality of discontinuity resistors.

25. The reference ladder of claim 18, wherein said discontinuity resistor comprises:
a plurality of coupled resistors; and
a plurality of switches, each switch coupled to a corresponding resistor of said plurality of coupled resistors, each switch configured to be switchable between a first switch state for conducting the current and a second switch state for not conducting the current;
wherein a plurality of switch states of the plurality of switches determines a total resistance of the discontinuity resistor.
